(19) United States
(12) Patent Application Publication
(10) Pub. No.: US 2010/0098207 A1
(43) Pub. Date: Apr. 22, 2010

(54) METHOD AND DEVICE TO PRODUCE HEAT AND POWER

(76) Inventor: Orhan Soykan, Shoreview, MN (US)

Correspondence Address: Orhan Soykan, 5255 Oxford Street North, Shoreview, MN, 55126-1301, US

(21) Appl. No.: 12/581,107

(22) Filed: Oct. 16, 2009

Related U.S. Application Data
(60) Provisional application No. 61/106,147, filed on Oct. 16, 2008.

(51) Int. Cl. G21C 3/07

(52) U.S. Cl. 376/412; 376/420; 376/424

(57) ABSTRACT

A method and device are described to form a heat producing plant with replaceable fusion-based reaction cartridges, where the fuel is embedded in casings in the preferred embodiment, and the heat can be converted into electrical or mechanical energy. The replaceable unit consists of sheets containing individual heating elements that are addressed sequentially to trigger the heat producing reactions. A controller governs the triggering activity until all the elements are used. The resulting heat can be converted into mechanical energy using turbines and into electrical energy using the Seebeck effect. This inventive device can be used in mobile environments as well as at fixed locations where heat, mechanical power or electricity are needed.

### CROSS-REFERENCE TO RELATED APPLICATIONS

This application claims priority to provisional application No. 61/106,147 (EFS ID: 4130432) filed on Oct. 16, 2008.

### STATEMENT REGARDING FEDERALLY SPONSORED RESEARCH OR DEVELOPMENT

None.

### THE NAMES OF THE PARTIES TO A JOINT RESEARCH AGREEMENT

None.

### REFERENCE TO SEQUENCE LISTING

None.

### REFERENCES

U.S. Pat. No. 4,454,850 “Apparatus and method for energy conversion”; Stephen Horvath; 19 Jun. 1984

U.S. Pat. No. 4,189,346 “Operationally confined nuclear fusion system”; William S. Jarnagin; 19 Feb. 1980

U.S. Pat. No. 4,182,651 “Pulsed deuterium lithium nuclear reactor”; Albert G. Fischer; 8 Jan. 1980

### OTHER REFERENCES

Nuclear and Particle Physics, B. R. Martin, John Wiley and Sons, 2006

Engineering Solid Mechanics: Fundamentals and Applications, A.-R. Ragad and S. E. Bayoumi, CRC Press, 1999

### BACKGROUND

Methods to generate heat and to convert the resulting thermodynamic gradient into electrical and mechanical power are well understood. As a result, steam engines, internal combustion engines and gas turbines have been used at fixed locations and in vehicles used for transportation. However, the burning of fossil fuels in these power plants produces carbon-dioxide, which is known to contribute to global warming, and its level in the atmosphere is increasing. Hence, there is a need to generate heat without the use of combustion processes.

### SUMMARY OF THE INVENTION

A novel method to generate heat using small pellets containing nuclear fusion material is provided. A device for the containment and activation of these fuel pellets to regulate the heat production is also provided. Further, the design and the build of engines to convert the resulting heat into mechanical and electrical power are taught.

### BRIEF DESCRIPTION OF THE DRAWINGS

The foregoing and other features and aspects of the present disclosure will be best understood with reference to the following detailed description of specific embodiments of the disclosure, when read in conjunction with the accompanying drawings, wherein:

FIG. 1 depicts the design of the fuel pellet,

FIG. 2 is a diagram of the shield halves between which the fuel pellets are enclosed,

FIG. 3 is a schematic of electrical connections built onto the shield halves,

FIG. 4 contains the listing of an example computer program used for the power plant design,

FIG. 5 lists the output from the computer program used for the power plant design,

FIG. 6 shows a section of a computer program that is used to obtain the simulated data shown on FIG. 7, and

FIG. 7 shows the results from the simulation of the described system, where the horizontal axis is the temperature of the system give in Kelvins and the vertical axis is the fuel pressure given in Atmospheres.

### DETAILED DESCRIPTION OF THE INVENTION

Generation of heat can be accomplished by physical processes such as electrical heating, by chemical processes such as exothermic reactions, and by nuclear processes such as fission and fusion. For physical processes, an external source of energy such as electrical or mechanical power is needed, hence they are not suitable for the production of electrical and mechanical power. Exothermic chemical processes can be used for the generation of electrical and mechanical power using steam plants, internal combustion engines and gas turbines in conjunction with other hardware such as electrical generators. Yet most chemical reactions used for the generation of power also produce carbon-dioxide, a greenhouse gas which, when over-abundant, contributes to global warming.

Nuclear processes such as fission and fusion can also be used for the production of energy in the form of heat. Controlled fission is the mechanism used in nuclear power reactors to heat water to produce steam for the generation of electrical power. Although this technology is well developed for large scale power plants, it is not suitable for use in homes or in vehicles because of the size of the large reaction chamber, the amount of radioactive fuel necessary, and the amount of waste produced.

Nuclear fusion is a more simple process and has been shown to produce large amounts of energy, at least when it is used in the form of an uncontrolled hydrogen bomb. However, efforts to build a controlled fusion reactor have not been very successful due to the difficulties experienced with containment of the high temperature reactants.

A fusion reaction is the merger of two or more atomic nuclei to form a new nucleus. During this process, a significant amount of energy as well as some small subatomic particles are released. However, being positively charged, the nucleus of one atom repels other nuclei which are also positively charged. This Coulomb repulsion must be overcome before fusion reactions can take place. For example, the energy barrier for the fusion of two deuteron nuclei is about 10⁶ electron-Volts (eV), which requires a temperature of 10¹⁰ degrees Kelvin (° K) to overcome [REF: Nuclear and Particle Physics, B. R. Martin, John Wiley and Sons, 2006, pp 266-7]. This temperature is higher than the melting temperature of all known materials, hence conventional reactor designs using metal casings cannot be used. Instead, techniques using magnetic or inertial confinement of the plasma hold the hot reactants long enough to allow the reaction to take place. The present invention utilizes a method that is a variation of the inertial confinement technique.

In the traditional method of inertial confinement, the fuel is encapsulated in small sacrificial shells. Each shell is suddenly heated to a very high temperature, causing it to explode. During this explosion, the outer portions of the shell material move outward. At the same time, the inner portions of the shell travel inward toward the center of the shell, as dictated by the principle of conservation of momentum. This implosion of the inner shell causes the compression and heating of the fuel material that is needed for ignition. The main difficulties associated with the use of this design are the need for locating and energizing each fuel pellet within the reaction chamber, and the need to remove the debris resulting from the individual explosions.

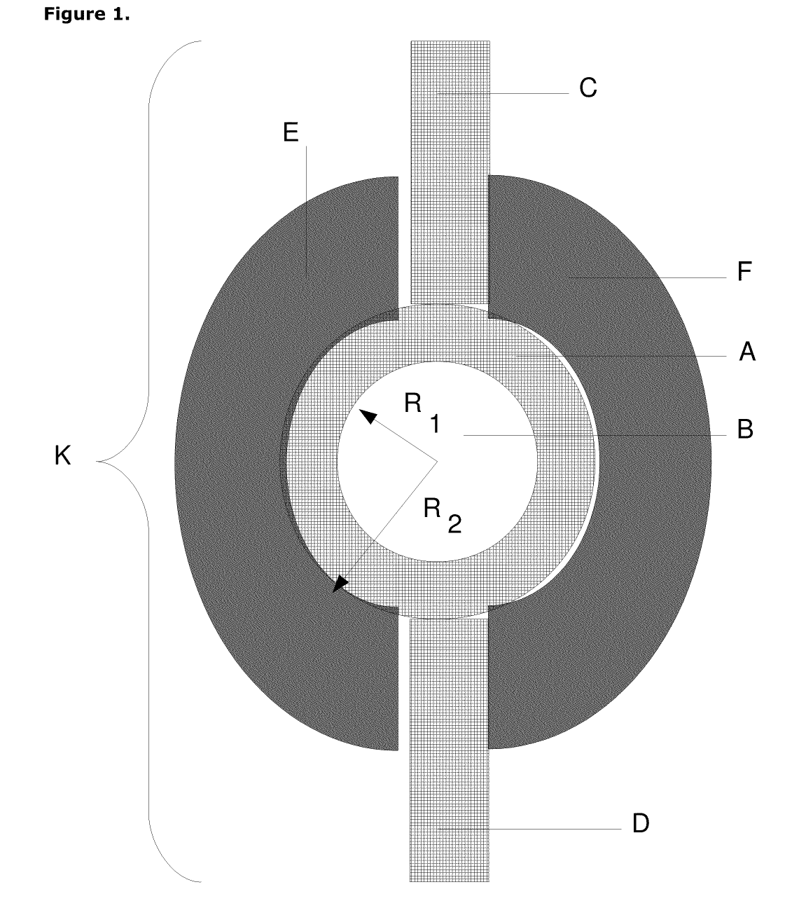

The present invention uses fuel pellets immobilized onto metal sheets or embedded into metal blocks. An individual pellet [K] is shaped like a sphere and consists of a metal shell [A] filled with fusion fuel [B] as shown in FIG. 1. On opposite ends, the metal shell has extensions [C] and [D] that can be used for sending electrical power through the metal shell. The inner void of the shell has radius r₁; the outer radius of the shell is r₂. Finally, the shell is encapsulated within two ceramic hemispheres [E] and [F] that provide a rigid background and insulate the fuel pellet from its surroundings both electrically and thermodynamically.

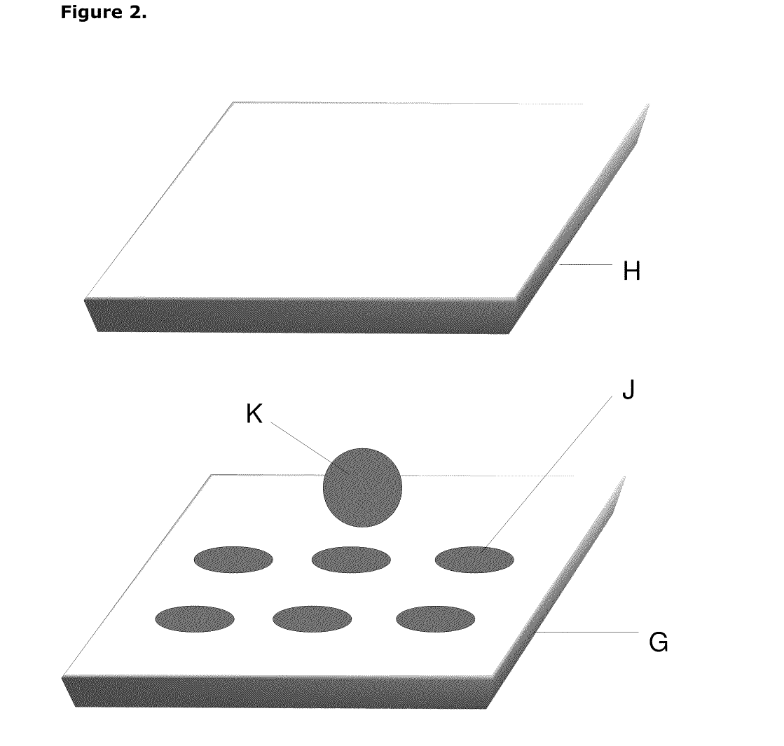

Individual pellets can be positioned between thin shields of metal as shown in FIG. 2. This is achieved using two shield halves [G] and [H]. These shield halves contain indentations shaped like semi-spheres [J] where the fuel pellets [K] will be located. When the two shield halves are placed together, the sheet with embedded fuel pellets is formed.

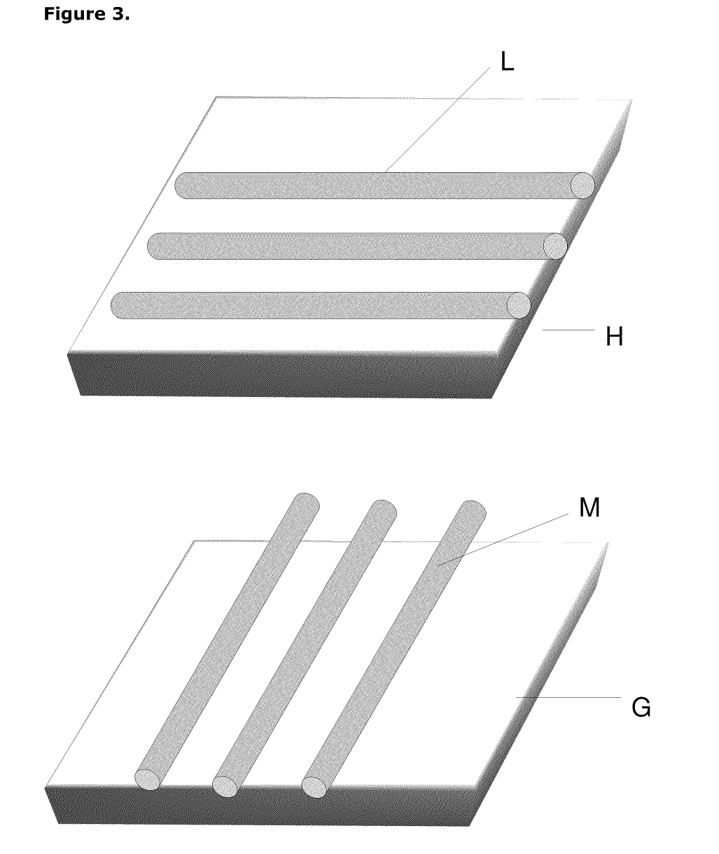

FIG. 3 shows the electrical connections or waveguides running to all fuel pellets placed within the sheets. Shield halves [G] and [H] contain electrical connections or waveguides [L] and [M] for making connections to the individual fuel pellets which are arranged at the intersections of the two dimensional array. One shield half [H] has the rows [L], and the other half [G] has the columns [M] of the connecting array. By selecting the row and column electrically, the electrical or electromagnetic energy can be delivered to one fuel pellet at a time.

The electrical or electromagnetic energy delivered to the pellet causes heating and expansion of the shell material. This is because the delivered electrical energy is confined to the metal shell which is insulated by the ceramic hemispheres. Although the volume of the metal shell of the fuel pellet does increase, the ceramic insulator and metal shield surrounding the shell do not allow a significant increase in the outer radius of the shell. This is because the proportionally much larger shield halves will not heat as rapidly and are considerably more rigid. Instead, the expanding metal shell compresses the fusion fuel within and brings it to the ignition point. Although the fusion reaction would produce enough heat to melt the pellet shell, it would self terminate due to the limited amount of fuel contained within the fuel pellet. Hence, instead of an ongoing chain reaction, continuous heat generation can be achieved by triggering reactions in the remaining fuel pellets via the electronics controlling the delivery of electrical or electromagnetic power. Heat generated by the fuel in individual pellets will be absorbed by the metal shield and will be recovered to do work.

Selection of the metal to build the pellet shell can be done as follows:

The volume of the void within the fuel pellet can be calculated as the volume of a sphere:

$${V}_{void} = \frac{4}{3} π {r}_{1}^{3} \qquad Equation 1$$

where r₁ is the radius of the void within the fuel pellet.

The total volume of the shell along with the void within can also be calculated as the volume of a sphere:

$${V}_{FULL} = \frac{4}{3} π {r}_{2}^{3} \qquad Equation 2$$

where r₂ is the outer radius of the metal shell.

The volume of the metal shell without the internal void can be calculated as the difference between V_{FULL} and V_{void}:

V_{Shell}=V_{FULL}−V_{void} Equation 3

If the outer dimensions of the shell cannot increase, then the maximum change in the volume of the shell, ΔV, will be equal to the entire void within:

ΔV=V_{void} Equation 4

The change in the volume of the metal shell can be calculated as a ratio:

$$\frac{Δ V}{{V}_{Shell}} = \frac{{V}_{void}}{{V}_{FULL} - {V}_{void}} \qquad Equation 5$$

Combining equations 1 and 2 with equation 5, we obtain:

$$\frac{Δ V}{{V}_{Shell}} = \frac{{V}_{void}}{{V}_{FULL} - {V}_{void}} = \frac{1}{{( \frac{{r}_{2}}{{r}_{1}} )}^{3} - 1} \qquad Equation 6$$

The equation for volumetric thermal expansion is given as:

$$\frac{Δ V}{{V}_{Shell}} = {α}_{V} Δ T \qquad Equation 7$$

where αᵥ is the volumetric thermal expansion coefficient and ΔT is the change in the temperature.

Combining equations 6 and 7,

$${( \frac{{r}_{2}}{{r}_{1}} )}^{3} = \frac{1}{{α}_{V} Δ T} + 1 \qquad Equation 8$$

To build a fuel pellet with a large void and a thin shell, one would need a large value for r₁ and a small value for r₂ (minimally larger than r₁), meaning that the ratio shown in equation 8 should be minimized. Minimization of the ratio can be achieved if the αᵥ ΔT product is maximized. To maintain the rigidity of the shell, it is preferred to choose metals with higher melting temperatures. Table 1 provides a list of metals, their corresponding volumetric thermal expansion coefficient, melting temperature, and the product of these two terms. Metals at the top of the list, such as steel, are preferred for building the shell.

TABLE 1
List of metals sorted in descending order of the product of
the temperature expansion coefficient and melting point.

| | Linear | | |
|---|---|---|---|
| | Expansion | | |
| | Coefficient | Melting Point | MeltPoint × |
| Metal | ×10⁻⁶/deg C. | Deg K | ExpCoeff |
| Plutonium | 54 | 913 | 49302.00 |
| Steel (Mild) | 12 | 1630-1750 | 40560.00 |
| Manganese | 22 | 1517 | 33374.00 |
| Potassium | 83 | 336.5 | 27929.50 |
| Sodium | 70 | 370.98 | 25968.60 |
| Thorium | 12 | 2023 | 24276.00 |
| Zinc | 35 | 692.7 | 24244.50 |
| Silver | 19 | 1234 | 23446.00 |
| Aluminium | 25 | 933 | 23325.00 |
| Magnesium | 25 | 923 | 23075.00 |
| Copper | 16.6 | 1357 | 22526.20 |
| Nickel | 13 | 1726 | 22438.00 |
| Iron | 12 | 1809 | 21708.00 |
| Cobalt | 12 | 1768 | 21216.00 |
| Tantalum | 6.5 | 3253 | 21144.50 |
| Niobium | 7 | 2740 | 19180.00 |
| Gold | 14.2 | 1336 | 18971.20 |
| Uranium | 13.4 | 1405 | 18827.00 |
| Beryllium | 12 | 1558 | 18696.00 |
| Platinum | 9 | 2043 | 18387.00 |
| Selenium | 37 | 490 | 18130.00 |
| Rhodium | 8 | 2238 | 17904.00 |
| Cadmium | 30 | 594 | 17820.00 |
| Lead | 29 | 600.7 | 17420.30 |
| Vanadium | 8 | 2173 | 17384.00 |
| Tungsten | 4.5 | 3673 | 16528.50 |
| Titanium | 8.5 | 1943 | 16515.50 |
| Osmium | 5 | 3298 | 16490.00 |
| Iridium | 6 | 2723 | 16338.00 |
| Molybdenum | 5 | 2893 | 14465.00 |
| Chromium | 6 | 2133 | 12798.00 |
| Tin | 20 | 505 | 10100.00 |
| Antimony | 9 | 903 | 8127.00 |
| Bismuth | 13 | 544 | 7072.00 |
| Silicon | 3 | 1684 | 5052.00 |
| Mercury | Â | 234.29 | 0.00 |

Next, the method to design the overall heat and power plant is described using an example case of a heat generator to power an automobile:

STEP 1. Determine the average power needed: A car on average requires 20 kW of power to drive.

STEP 2. Determine the efficiency of the power converter, and update the overall total demand: If the heat will be converted into electromechanical power, then a turbine with a typical efficiency of 75% can be used. To extract 20 kW of power, one needs to supply 20 kW/0.75=26,667 Watts from the heat generator.

STEP 3. Determine the type of fusion fuel to use, and the resulting energy from the reaction: Deuterium is a convenient reactant since it naturally occurs and is not radioactive. Fusion of two deuterium atoms yields 3.27 MeV, which is 5.239×10⁻¹³ Joules.

STEP 4. Determine the reaction efficiency: It can be expected that not all of the fuel would react. For this example, it will be assumed that only half of the fuel will react, meaning that the reaction efficiency is 50%.

STEP 5. Calculate the number of reactions needed per second:

$$N = \frac{\frac{AveragePowerNeeded}{PowerConverterEfficiency}}{\frac{ReactionEnergy}{ReactionEfficiency}} = 1.018 \times {10}^{17} individual reactions per second .$$

STEP 6. Determine the pressure to store the fuel: In order keep the pellet size small, the fuel can be stored at high pressure. For this example, a pressure of 100 Atmospheres will be used.

STEP 7: Calculate the volume of space required to hold the fuel in a pellet:

$${V}_{void} = \frac{2 N}{6.022 \times {10}^{23}} \frac{0.0224}{pressure} = 7.573 \times {10}^{- 11} {m}^{3}$$

STEP 8: Calculate the radius of the void sphere:

$${r}_{1} = \sqrt[3]{\frac{3 {V}_{void}}{4 π}} = 0.262 mm$$

STEP 9: Determine the desired change in temperature as a result of the electrical heating of the pellet shell: For steel, the melting temperature is about 1,600 degrees Kelvin. This would allow a temperature change of at least 1,000 degrees Kelvin above the operating point without melting the shell.

STEP 10: Determine the temperature expansion coefficient of the shell material: For steel, it is 32.4×10⁻⁶

STEP 11: Calculate the outer shell radius which will provide enough shell material to fill up the void when the shell is heated:

$${r}_{2} = {r}_{1} \sqrt[3]{1 + \frac{1}{{α}_{V} Δ T}} = 0.832 mm$$

STEP 12: Determine the dimensions of the sheet of embedded pellets: For this example, the length of the sheet will be set as 50 cm and height as 30 cm.

STEP 13: Calculate how many pellets can be placed into a sheet if they were placed with a spacing equal to the size of the pellets:

$${N}_{sheet} = \frac{length \times height}{4 {r}_{2}^{2}} = 13 , 540 pellets per sheet$$

STEP 14: Calculate how long each sheet would last at a rate of igniting one pellet per second:

$${t}_{sheet} = \frac{{N}_{sheet}}{3 , 600} = 3.76 hours$$

STEP 15: Determine the width of a block of fuel sheets, and the number of sheets that can be stored in that block if the spacing between the sheets is 1 mm: For a chosen block width of 30 cm, one can place:

$${Count}_{sheet} = \frac{width}{4 {r}_{2} + 0.001} = 69 sheets$$

STEP 16: Calculate how long that entire block of sheets would last:

tₜₒₜₐₗ=tₛₕₑₑₜ×Countₛₕₑₑₜ=259.52 hours

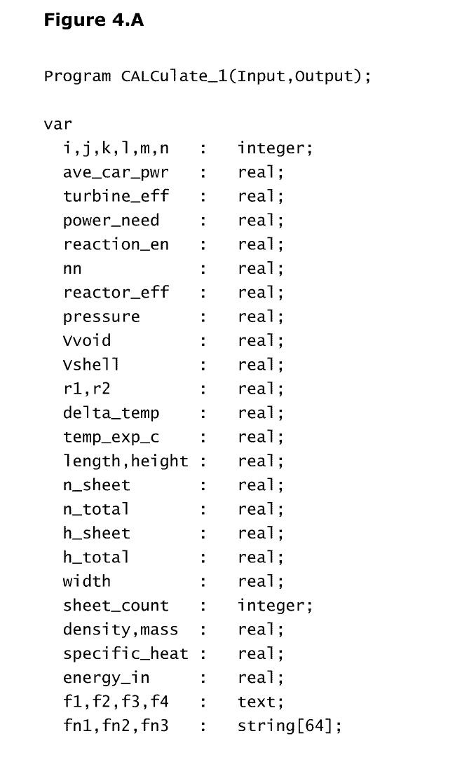

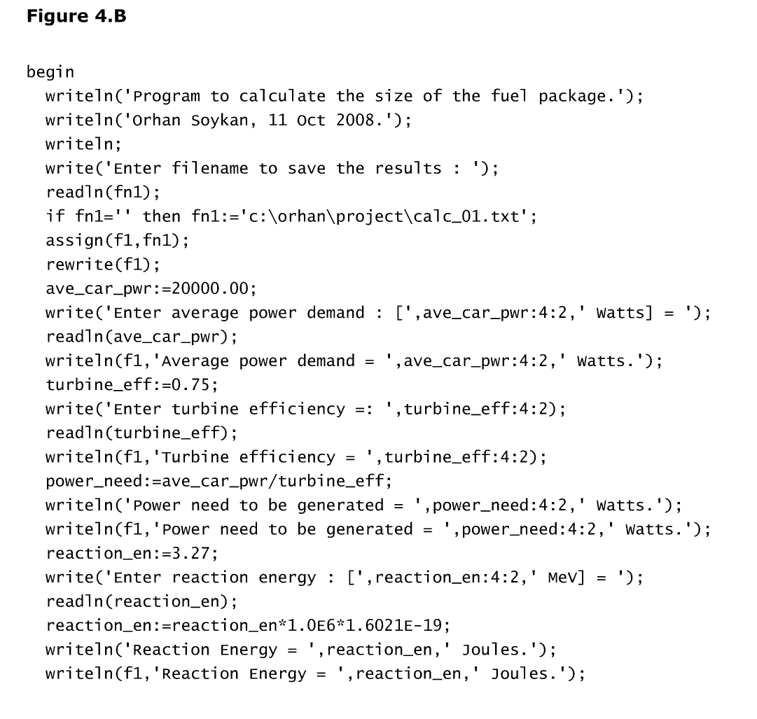

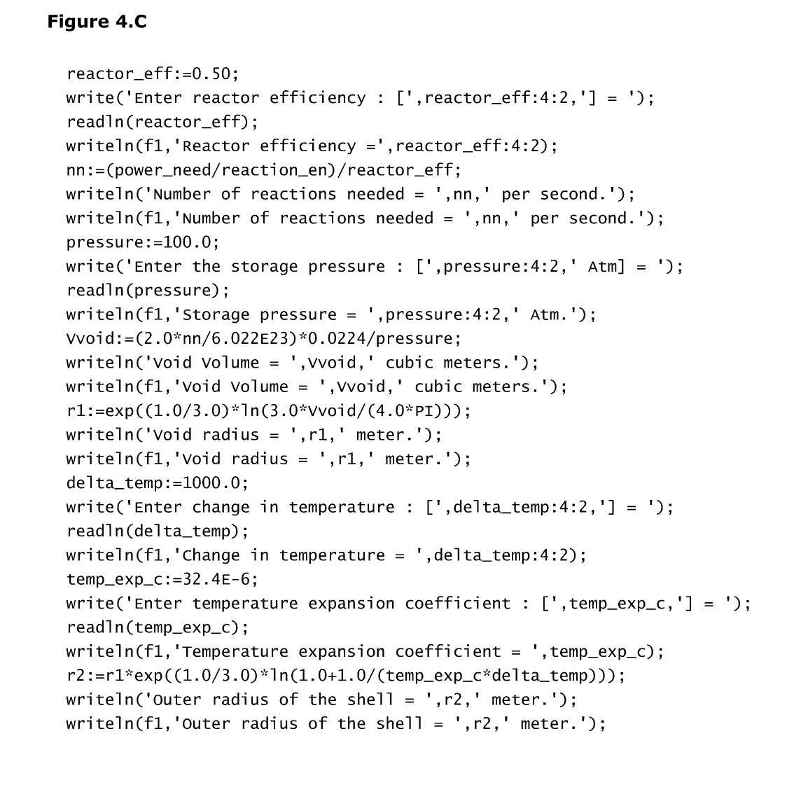

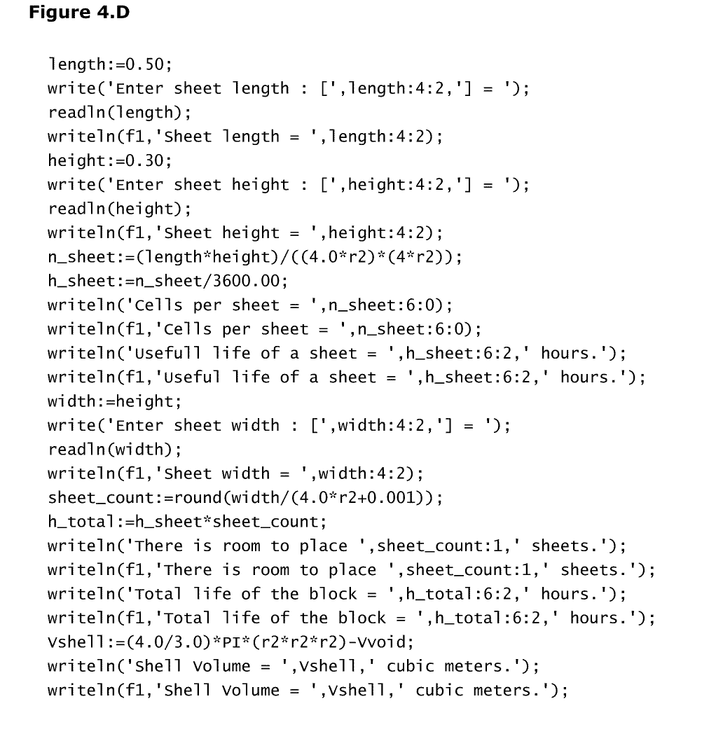

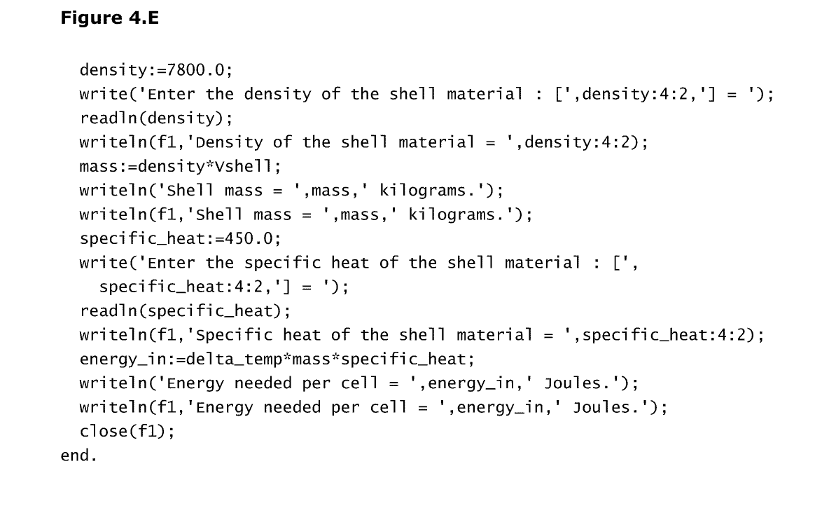

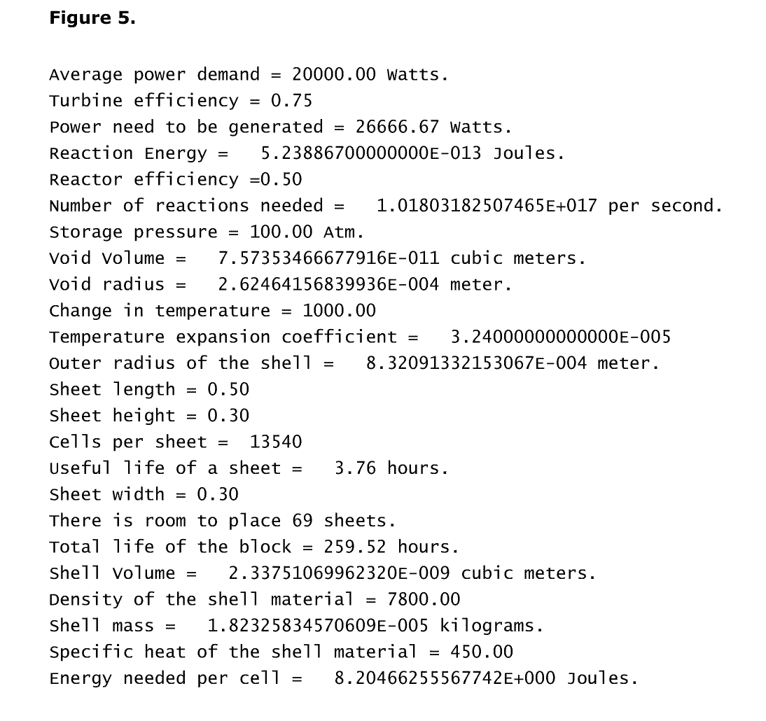

Calculations for the above described steps were performed using a computer program. A listing of the subject program is shown in FIG. 4, and the output of the program is shown in FIG. 5.

As can be seen from the above example, the power plant described in the present invention can be used to produce heat continuously, which can then be converted into electromechanical energy.

Individuals skilled in the art would be able to see variations of the present invention. For example, the metal shell can be constructed in layers and some sacrificial layers can be rapidly evaporated to create the sudden implosion. Modifications to the shape of the pellets can also be incorporated to improve the ignition.

It is preferable to have an electronic controller where the overall sheet or block is maintained at a given temperature. If the energy consumption is high, then the temperature would drop and the controller would respond by increasing the rate of activation of pellets. Conversely, if the plant begins to overheat, then the controller would reduce the rate of activation or would suspend it all together to prevent overheating.

As it can be seen from the above description, the basic heat generation device can be constructed using the method described. However, further consideration should be given to the actual thermodynamic conditions of the fuel inside the shell. Although the fuel is compressible, the back pressure exerted by the gas on the metal shell A would create a counter pressure on the shell, and compress the shell itself, determined by the elastic modulus of the shell material. For example, for steel, the modulus of elasticity is 200 MegaPascals, indicating that steel shell will be compressed by the gas, preventing the complete elimination of void as the shell expands. The remedy for this situation is described below.

Stresses on large solid sphere with internal pressure, P₁ are given as follows:

$${σ}_{r} = {P}_{1} \frac{{r}_{1}^{3}}{{r}^{3}} and {σ}_{φ} = {σ}_{θ} = {P}_{1} \frac{{r}_{1}^{3}}{2 {r}^{3}}$$

where σᵣ is the radial component of the stress while σ_{θ} and σ_{φ} are the angular components of the stress.

Due to the geometric confinement of the sphere, the radial strain be non-zero, which would in turn reduce the volume inside the sphere that is given by

$$\frac{4}{3} Π {r}^{3} .$$

Using the equation for σᵣ along with the formula for the volume of the spherical void and the ideal gas law (PV=nRT), the pressure inside the thick walled sphere containing the gas can be found as follows:

$${P}_{r} ( r ) = \frac{nRT}{\frac{4}{3} Π {r}^{3}}$$

This last equation shows that the pressure inside the sphere would in fact reach to very high values as the inner radius is reduced. Hence, it is paramount that the thermal expansion of the steel shell must provide the force necessary to compress the inner space and reduce the volume of the gas filled void to bring the pressure to a level sufficient for the ignition of the fuel.

It can be understood that the smaller inner volumes can be compressed more readily than the larger volumes, since the forces generated by the outer portions of the shell are all focused on the inner void. Therefore, instead of compressing one large volume of fuel, it would be more practical to compress many voids, each having smaller volumes.

Strain on a block of solid which is under stress and experiences thermal inputs is given as follows:

ε_{ZZ}=[−σ_{ZZ}+ν(σ_{XX}+σ_{YY})]/E+αΔT

where σ^{ZZ} is the strain along the measurement axis,
σ_{XX} and σ_{YY} are the strains along the orthogonal axis,
v is the Poisson's ratio,
E is the modulus of elasticity,
α is the coefficient of linear thermal expansion, and
ΔT is the change in the temperature.

By using the above equation to determine the stress and strains resulting on the solid shell along with the back pressure applied by the fuel in the inner void, one can calculate the pressures that are building in the inner cavity. In this process, heating of the shell is increases the radial stress and the strain, reducing the void radius while the gas pressure compresses the walls of the shell.

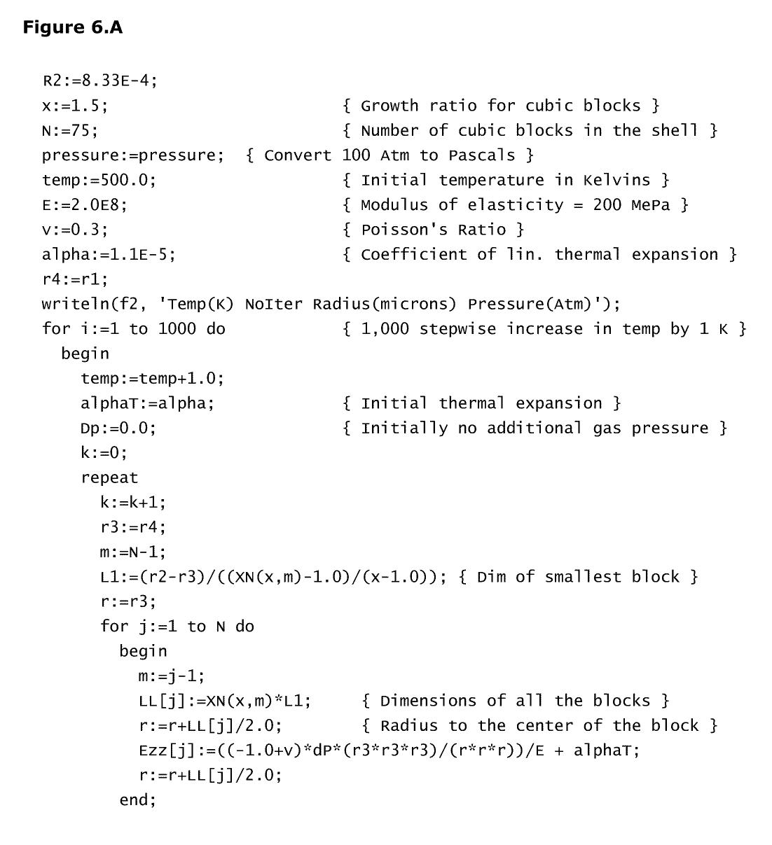

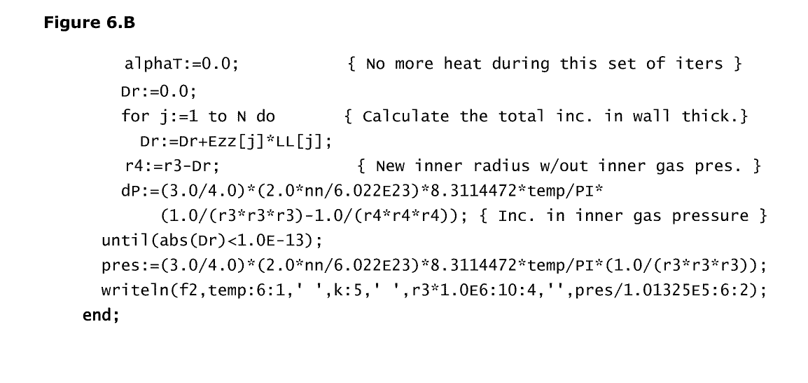

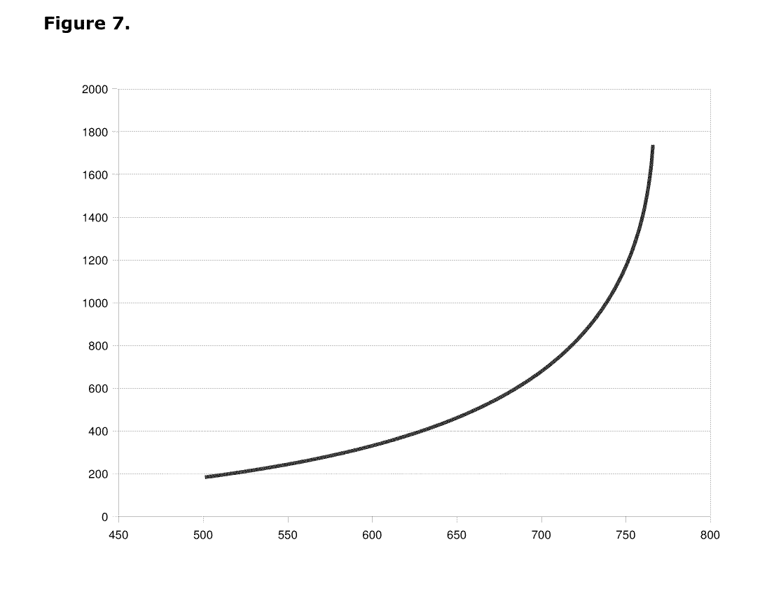

A computer program that is shown in FIG. 6 was used for the simulations. In this case, an shell inner radius of 12 micro-meters and outer shell radius of 833 micro-meters was used. Results of the simulations are shown on FIG. 7 as a temperature versus pressure curve. As the trace indicates, the curve becomes very steep before temperature reaches 800 Kelvin, much lower than the melting temperature of steel. Therefore, the fuel would be compressed dramatically and ignited soon after this point.

Since each void with a radius of 12 micro-meters would generate only 2 Joules, one would need to place many of them inside the compression units to generate the desired amount of heat.

The present invention can be used purely for heating, as in the case of residential and commercial heating units. It can be used for industrial heating purposes such as desalination of water. It can also be used as a primary heat generator for a thermodynamic power plant where electrical or mechanical power generation occur. Two embodiments for this latest version are described below.

### Embodiment 1

In embodiment 1, the conversion of heat to mechanical energy is accomplished using a gas turbine. Sheets described by the present invention are positioned in the expansion chamber of the turbine. Compressed gas flows into the chamber from a small port and is heated upon contact with the sheets containing activated pellets. The resulting high pressure gas leaves the chamber through a large port and turns the turbine blades at the exhaust port, which provides the power to compress intake gas and also provides the power to the external load, such as an automobile.

### Embodiment 2

In embodiment 2, the conversion of heat to electrical energy is accomplished using the Seebeck principle. Heat is allowed to flow from the plant to an external heat sink, and electricity is generated along the way.

The invention claimed is:

1. A method of building individually ignitable fuel pellets for fusion reactions, which consist of (a) metal shells in physically confined locations and (b) electrical contacts and insulators for addressing and activating those pellets under control.

2. A method of constructing arrays of the fuel pellets of claim 1, wherein the electrically isolated pellets are embedded into sheets along with electrical contacts.

3. A method of building a heat plant comprised of: a) a multi-dimensional array of electrically addressable fuel pellets; and b) a temperature-controller activating the pellets at varying rates.

4. A method of converting the heat from the plant of claim 3, wherein the heat from the plant is used to generate mechanical power.

5. A method of converting the heat from the plant of claim 3, wherein the heat from the plant is used to generate electrical power.
